(19) United States
(12) Patent Application Publication
(10) Pub. No.: US 2024/0161263 A1
(43) Pub. Date: May 16, 2024

(54) METHOD FOR INSPECTING DEFECTS OF PRODUCT BY USING 2D IMAGE INFORMATION

(71) Applicant: VAZIL Company Co.,Itd, Busan (KR)

(72) Inventors: Sungwon KIM, Daegu (KR); Minkyu KIM, Yangsan-si (KR); Mustafaev GOFUROVICH BEKHZOD, Busan (KR); Tursunov AKHMADALI UGLI ANVARJON, Busan (KR)

(73) Assignee: VAZIL Company Co.,Itd, Busan (KR)

(21) Appl. No.: 18/203,811

(22) Filed: May 31, 2023

(30) Foreign Application Priority Data
Nov. 15, 2022 (KR) 10-2022-0152776
Mar. 23, 2023 (KR) 10-2023-0037941
Mar. 23, 2023 (KR) 10-2023-0037942
Apr. 20, 2023 (KR) 10-2023-0052216

(51) Int. Cl. G06T 7/00; G06T 5/00

(52) U.S. Cl. CPC G06T 7/0004; G06T 5/009; G06T 2207/20084

(57) ABSTRACT

Disclosed is a method for predicting presence or absence of a defect of a product, which is performed by one or more processors. The method may include: obtaining one or more images; inputting the obtained image into a neural network model, and generating a plurality of feature maps; extracting a first feature vector based on the plurality of feature maps; extracting a second feature vector for identifying a feature map related to the presence or absence of the defect among the plurality of feature maps based on the extracted first feature vector; extracting a third feature vector for identifying a feature map region related to the presence or absence of the defect based on the plurality of feature maps; and predicting the presence or absence of the defect based on the first feature vector, the second feature vector, and the third feature vector by using the neural network model.

### CROSS-REFERENCE TO RELATED APPLICATIONS

This application claims priority to and the benefit of Korean Patent Application No. 10-2022-0152776 filed in the Korean Intellectual Property Office on Nov. 15, 2022, the entire contents of which are incorporated herein by reference.

### TECHNICAL FIELD

The present disclosure relates to a method for inspecting defects of a product by using 2D image information, and more particularly, to a method for inspecting defects in real time by utilizing 2D image information when inspecting defects of a product.

### BACKGROUND ART

In the case of inspecting defects of a product by using a conventional 3D camera, it is difficult to use the conventional 3D camera to inspect defects in real time due to high price and long processing time.

In addition, human workers have been conventionally used to inspect a quality when inspecting the defects of the product, but due to eye fatigue, it is difficult to perform a high-level precision inspection process during the inspection time, and in order to an accurate task to be continuously performed, it was necessary to take a break at a specific time, and each worker had to have sufficient experience in analyzing the product for an inspection quality. Therefore, there has been a problem that production efficiency is lowered when the quality is inspected using the human workers.

Therefore, considering the high price, long processing time, and consistency of quality inspection, which were problems in the conventional product defect inspection, a method to ensure consistency of the quality inspection while reducing the processing time and cost of defect inspection is required, and a new technology capable of solving the problems or disadvantages is required.

On the other hand, the present disclosure has been derived at least based on the technical background described above, but the technical problem or object of the present disclosure is not limited to solving the problems or disadvantages described above. That is, the present disclosure may cover various technical issues related to the content to be described below, in addition to the technical issues discussed above.

### SUMMARY OF THE INVENTION

The present disclosure has been made in an effort to inspect defects in real time by using 2D image information when inspecting defects of a product.

Meanwhile, a technical object to be achieved by the present disclosure is not limited to the above-mentioned technical object, and various technical objects can be included within the scope which is apparent to those skilled in the art from contents to be described below.

An exemplary embodiment of the present disclosure provides a method performed by a computing device. The method may include: obtaining one or more images; inputting the obtained image into a neural network model, and generating a plurality of feature maps; extracting a first feature vector based on the plurality of feature maps; extracting a second feature vector for identifying a feature map related to presence or absence of a defect among the plurality of feature maps based on the extracted first feature vector; extracting a third feature vector for identifying a feature map region related to the presence or absence of the defect based on the plurality of feature maps; and predicting the presence or absence of the defect based on the first feature vector, the second feature vector, and the third feature vector by using the neural network model.

Alternatively, the one or more images may include one or more 2D images, and the obtaining of the one or more images may include obtaining one or more images of a front image, a back image, a right image, a left image, a top image, or a bottom image of the product.

Alternatively, the inputting of the obtained image into the neural network model, and the generating of the plurality of feature maps may include performing gamma correction for the obtained image, and inputting the gamma-corrected image into the neural network model.

Alternatively, the inputting of the obtained image into the neural network model, and the generating of the plurality of feature maps may include extracting features of the image by using a plurality of first convolution layers and a plurality of first pooling layers included in the neural network model, and generating the plurality of feature maps based on the extracted features.

Alternatively, the extracting of the first feature vector based on the plurality of feature maps may include extracting the first feature vector by performing additional pooling on the plurality of feature maps.

Alternatively, the extracting of the second feature vector for identifying the feature map related to the presence or absence of the defect among the plurality of feature maps based on the extracted first feature vector may include inputting the first feature vector into one or more first fully-connected layers, and extracting the second feature vector for identifying the feature map related to the presence or absence of the defect among the plurality of feature maps.

Alternatively, the extracting of the third feature vector for identifying the feature map region related to the presence or absence of the defect based on the plurality of feature maps may include inputting the plurality of feature maps into one or more second convolution layers, and applying a convolution operation, and performing additional pooling for the feature maps to which the convolution operation is applied, and extracting the third feature vector for identifying the feature map region related to the presence or absence of the defect.

Alternatively, the additional pooling may include global average pooling.

Alternatively, the predicting the presence or absence of the defect based on the first feature vector, the second feature vector, and the third feature vector by using the neural network model may include generating a first synthesized vector by concatenating the second feature vector and the third feature vector, generating a final synthesized vector by concatenating the first synthesized vector and the first feature vector, and predicting the presence or absence of the defect based on the final synthesized vector.

Alternatively, the predicting of the presence or absence of the defect based on the final synthesized vector may include inputting the final synthesized vector into one or more second fully-connected layers and predicting the presence or absence of the defect.

Another exemplary embodiment of the present disclosure provides a computer program stored in a computer-readable storage medium. The computer program allows one or more processors to perform operations for predicting presence or absence of a defect of a product when the computer program is executed by one or more processors, and the operation may include an operation of obtaining one or more images; an operation of inputting the obtained image into a neural network model, and generating a plurality of feature maps; an operation of extracting a first feature vector based on the plurality of feature maps; an operation of extracting a second feature vector for identifying a feature map related to the presence or absence of the defect among the plurality of feature maps based on the extracted first feature vector; an operation of extracting a third feature vector for identifying a feature map region related to the presence or absence of the defect based on the plurality of feature maps; and an operation of predicting the presence or absence of the defect based on the first feature vector, the second feature vector, and the third feature vector by using the neural network model.

Still another exemplary embodiment of the present disclosure provides a computing device. The device may include: at least one processor; and a memory, and the processor may be configured to obtain one or more images, input the obtained image into a neural network model, and generate a plurality of feature maps, extract first feature vector based on the plurality of feature maps, extract a second feature vector for identifying a feature map related to presence or absence of a defect among the plurality of feature maps based on the extracted first feature vector, extract a third feature vector for identifying a feature map region related to the presence or absence of the defect based on the plurality of feature maps, and predict the presence or absence of the defect based on the first feature vector, the second feature vector, and the third feature vector by using the neural network model.

According to an exemplary embodiment of the present disclosure, a method for inspecting defects of a product by using 2D image information can be provided, and through this, defects can be inspected in real time by utilizing 2D image information when inspecting defects of a product.

Meanwhile, the effects of the present disclosure are not limited to the above-mentioned effects, and various effects can be included within the scope which is apparent to those skilled in the art from contents to be described below.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device for inspecting defects of a product by using 2D image information according to an exemplary embodiment of the present disclosure.

FIG. 2 is a schematic view illustrating a network function according to an exemplary embodiment of the present disclosure.

FIG. 3 is a flowchart illustrating a method for inspecting defects of a product by using 2D image information according to an exemplary embodiment of the present disclosure.

FIG. 4 is a schematic view illustrating a process of obtaining one or more images and performing gamma correction for the obtained images according to the exemplary embodiment of the present disclosure.

FIG. 5 is a schematic view illustrating a process of inputting the obtained images into a neural network model, extracting features of the images by using a plurality of first convolution layers and a plurality of first pooling layers included in the neural network model, and generating a plurality of feature maps based on the extracted features according to the exemplary embodiment of the present disclosure.

FIG. 6 is a schematic view illustrating a process of extracting a first feature vector, a second feature vector, and a third feature vector based on a plurality of feature maps according to the exemplary embodiment of the present disclosure.

FIG. 7A is a schematic view illustrating a process of extracting a second feature vector for identifying a feature map related to presence or absence of a defect among the plurality of feature maps based on the extracted first feature vector according to the exemplary embodiment of the present disclosure.

FIG. 7B is a schematic view illustrating a process of extracting a third feature vector for identifying a feature map region related to presence or absence of a defect based on the plurality of feature maps according to the exemplary embodiment of the present disclosure.

FIG. 8 is a schematic view illustrating a process of predicting presence or absence of a defect based on a first feature vector, a second feature vector, and a third feature vector by using a neural network model according to the exemplary embodiment of the present disclosure.

FIG. 9 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components.

One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”. Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally In terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a network function and an artificial neural network and a neural network may be interchangeably used.

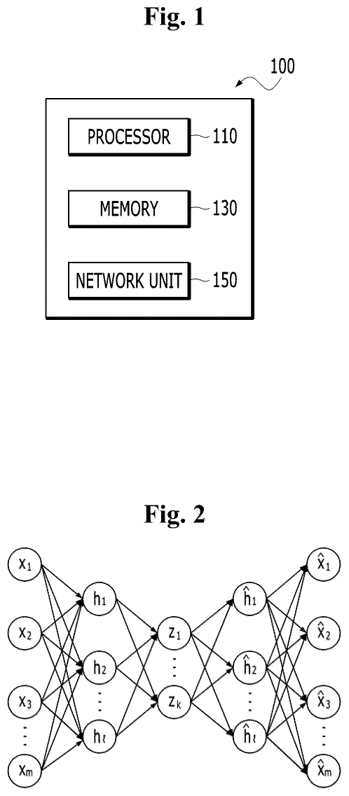

FIG. 1 is a block diagram of a computing device for inspecting defects of a product by using 2D image information according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100. The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for training the neural network. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network unit 150 presented in the present disclosure may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

In the present disclosure, the network unit 150 may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth. The techniques described in the present disclosure may also be used in other networks mentioned above.

FIG. 2 is a conceptual view illustrating a neural network according to an exemplary embodiment of the present disclosure.

A neural network model according to the exemplary embodiment of the present disclosure may include a neural network for evaluating placement of the semiconductor device. Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be trained in at least one scheme of supervised learning, unsupervised learning, semi supervised learning, or reinforcement learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data. As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

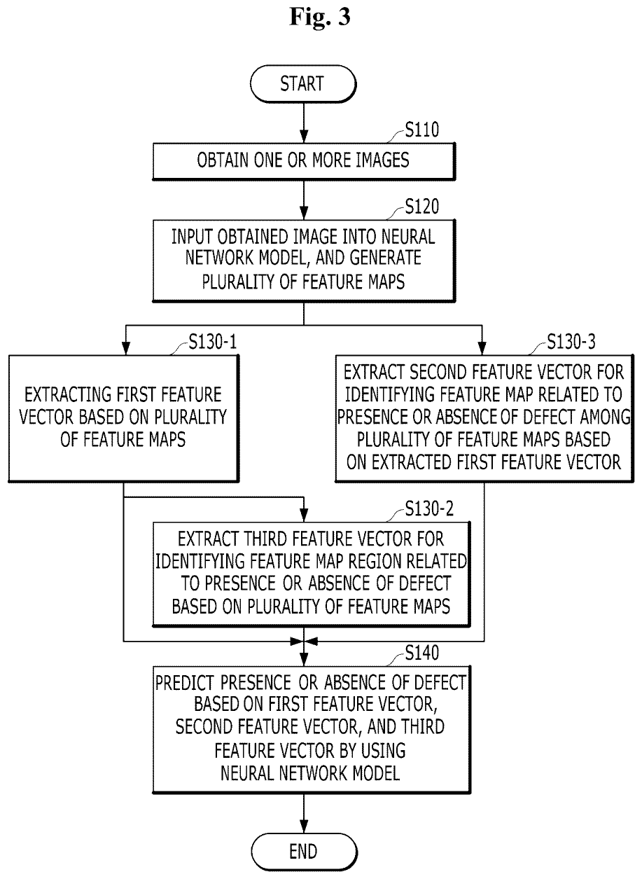

FIG. 3 is a flowchart illustrating a method for inspecting defects of a product by using 2D image information according to an exemplary embodiment of the present disclosure.

A computing device 100 according to an exemplary embodiment of the present disclosure may directly obtain “image information for inspecting defects of a product” or receive the “image information for inspecting defects of a product” from an external system. The external system may be a server or database that stores and manages image information. The computing device 100 may use the image information obtained directly or received from the external system as “input data for inspecting the defects of the product”.

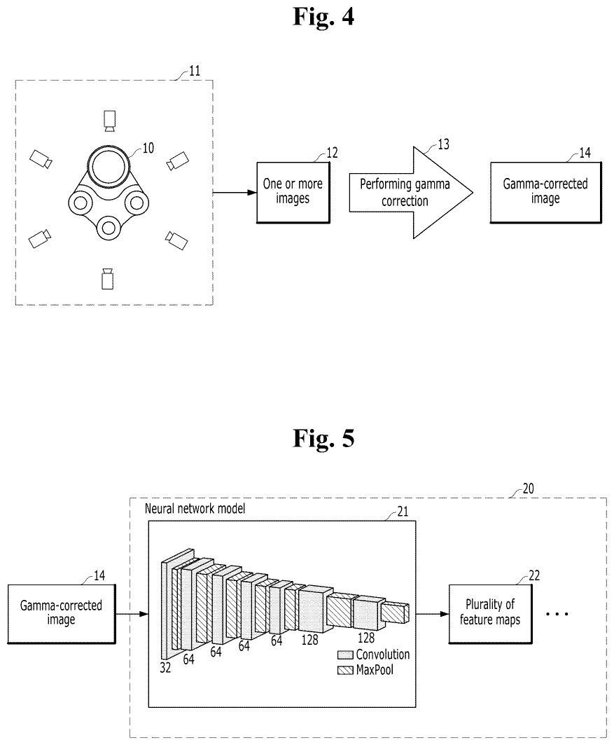

The computing device 100 may obtain one or more images (S110). For example, one or more images may include an image of the product for inspecting the defects. Specifically, the image of the product for inspecting the defects may include images of fabric, bottle, vehicle body surface, metal, and the like. Further, the one or more images may include images of a three-dimensional (3D) mechanical product such as a ball joint socket, and may include one or more 2D images. Meanwhile, according to an exemplary embodiment of the present disclosure, the computing device 100 may obtain one or more images of a front image, a back image, a right image, a left image, a top image, or a bottom image of the product. A specific process of obtaining one or more images will be described later with reference to FIG. 4.

The computing device 100 may input the image obtained through step S110 to the neural network model and generate a plurality of feature maps (S120). For example, the computing device 100 may perform gamma correction for the obtained image and input the gamma-corrected image to the neural network model. At this time, when the obtained image is an image for the product of a metal material, since the light reflection value of the surface may be different, an intensity of light of the obtained image is reduced through the gamma correction to obtain a clear image of the product without light reflection. A specific process of performing the gamma correction for the image obtained through step S110 and obtaining the corrected image will be described later with reference to FIG. 4.

The computing device 100 may input the image for which the gamma correction is performed into the neural network model, and generate the plurality of feature maps. For example, the computing device 100 may extract features of the images by using a plurality of first convolution layers and a plurality of first pooling layers included in the neural network model, and generating the plurality of feature maps based on the extracted features. Specifically, the computing device 100 may input the image for which the gamma correction is performed into a structure in which a plurality of first convolution layers and a plurality of first pooling layers are alternately connected, extract the features of the images, and generate the plurality of feature maps based on the extracted features. In this case, the plurality of first convolution layers may be used to extract image features required for classification from the input image. For example, a convolution operation is performed while passing the image through the plurality of first convolution layers, and the passed image is made to pass through the plurality of first pooling layers alternately connected to the plurality of first convolution layers, and Max pooling is performed to extract the features of the input image, and the plurality of feature maps may be generated based on the extracted features of the image. At this time, the reason for performing the Max pooling is that \textcircled{1} the largest feature value has the greatest influence on the calculation, so the largest feature value has the greatest influence on the output value and \textcircled{2} represents the feature the best. A specific process of extracting the features of the image by using the plurality of first convolution layers and the plurality of first pooling layers included in the neural network model, and generating the plurality of feature maps based on the extracted features will be described below through FIG. 5.

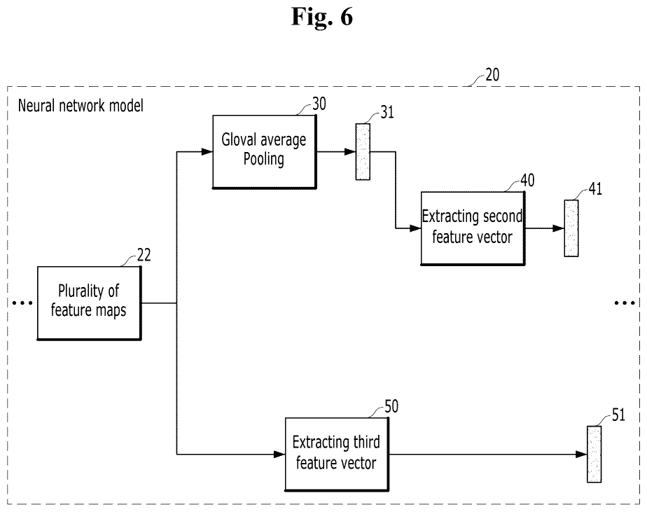

The computing device 100 may extract a first feature vector based on the plurality of feature maps generated through step S120 (S130-1). For example, the computing device 100 may extract the first feature vector by performing additional pooling on the plurality of feature maps. Specifically, the computing device 100 may perform global average pooling for the plurality of feature maps, and extract the first feature vector. At this time, by performing the global average pooling for the plurality of feature maps for each channel, one feature map of a size of H×W may be converged to one value, so the plurality of feature maps may be extracted as one first feature vector. The extracted first feature vector may be used in a process of extracting a second feature vector for identifying the feature map related to presence or absence of a defect among the plurality of feature maps, and a process of predicting the presence or absence of the defect by using the neural network model, and a detailed description thereof will be described later through FIGS. 6, 7A, and 8.

The computing device 100 may extract the second feature vector for identifying a feature map related to the presence or absence of the defect among the plurality of feature maps based on the first feature vector extracted through step S130-1 (S130-2). Specifically, the computing device 100 may input the first feature vector into one or more first fully-connected layers, and extract the second feature vector for identifying a feature map related to the presence or absence of the defect among the plurality of feature maps. For example, the global average pooling is performed on the plurality of feature maps to remove spatial information, and the first feature vector with only channel information remaining is input into two first fully-connected layers, so an importance level is learned for each channel, and the second feature vector for identifying the feature map related to the presence or absence of the defect among the plurality of feature maps may be extracted. The extracted second feature vector may be used in the process of predicting the presence or absence of the defect by using the neural network model, and a detailed description thereof will be described later with reference to FIGS. 6, 7A, and 8.

The computing device 100 may extract a third feature vector for identifying a feature map region related to the presence or absence of the defect based on the plurality of feature maps generated through step S120 (S130-3). Specifically, the computing device 100 may input the plurality of feature maps into one or more second convolution layers, apply the convolution operation, perform additional pooling for the feature maps to which the convolution operation is applied, and extract the third feature vector for identifying the feature map region related to the presence or absence of the defect. For example, the computing device 100 may perform the global average pooling for the feature maps to which the convolution operation is applied, and extract the third feature vector for identifying the feature map region related to the presence or absence of the defect. In this case, the computing device 100 may input the plurality of feature maps into one or more second convolution layers, apply the convolution operation to delete information on a channel and generate a feature map having a spatial importance, and perform the global average pooling for the feature map having the generated spatial importance to extract the third feature vector for identifying the feature map region related to the presence or absence of the defect. The extracted third feature vector may be used in the process of predicting the presence or absence of the defect by using the neural network model, and a detailed description thereof will be described later with reference to FIGS. 6, 7B, and 8.

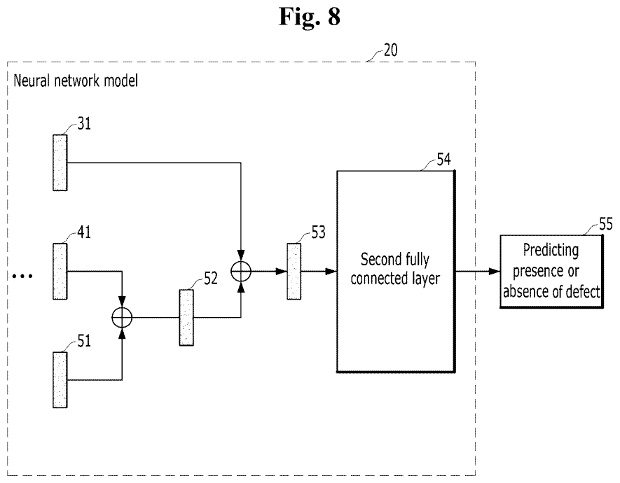

The computing device 100 may predict the presence or absence of the defect based on the first feature vector generated through step S130-1, the second feature vector generated through step S130-2, and the third feature vector generated through step S130-3 by using the neural network model (S140). For example, the computing device 100 may generate a first synthesized vector by concatenating the second feature vector and the third feature vector, generate a final synthesized vector by concatenating the first synthesized vector and the first feature vector, and predict the presence or absence of the defect based on the final synchronized vector. Specifically, the computing device 100 may input the final synthesized vector into one or more second fully-connected layers and predict the presence or absence of the defect. A detailed description of a process of predicting the presence or absence of the defect based on the final synthesized vector will be described later with reference to FIG. 8.

FIG. 4 is a schematic view illustrating a process of obtaining one or more images and performing gamma correction for the obtained images according to the exemplary embodiment of the present disclosure.

Referring to FIG. 4, the computing device 100 according to an exemplary embodiment of the present disclosure may obtain one or more images 12 for a product 10 in order to inspect the defect of the product (11). Specifically, an image of a product which becomes a target for inspecting the defect may include images of fabric, bottle, vehicle body surface, metal, and the like. Further, the one or more images may include images of a three-dimensional (3D) mechanical product such as a ball joint socket, and may include one or more 2D images. On the other hand, a defect inspection procedure of a 3D mechanical product such as a ball joint socket has a problem in that a defect inspection process is more difficult because the defect may occur in any part of a 3D product, and in general, data for defect inspection is collected by using a 3D camera, but cost is much higher than that of an image of a 2D camera, and since various preprocessing processes such as 3D data point processing should be performed, it takes a lot of work time compared to using the 2D camera image, so it is difficult to inspect the defect in real time. Unlike this, according to an exemplary embodiment of the present disclosure, the computing device 100 may capture images of all parts of a 3D object at various angles, which include a front image, a back image, a right image, a left image, a top image, or a bottom image of the product with the 2D camera (11), and obtain one or more images (12). In this case, the processing time of the 2D image is shorter than that of 3D camera data, so the processing time may be applied to defect inspection in real time, and the cost is relatively low because the preprocessing process is relatively simple compared to the 3D camera data.

A computing device 100 according to an exemplary embodiment of the present disclosure may use one or more images 12 directly obtained or received from an external system as input data for inspecting the defect of the product. Meanwhile, one or more images 12 are not limited to a front image, a back image, a right image, a left image, a top image, or a bottom image of the product, and may also include images captured at various angles in addition to the examples. In addition, the product 10 is not limited to the ball joint socket, and may include various 3D products which become targets of the defect inspection in addition to the examples.

The computing device 100 may perform gamma correction for the one or more images 12 (13). Meanwhile, when the product which becomes the target for the defect inspection is a metal product, light reflectance of the product may be different for each part of the surface, and a balance between a light source and an intensity may be a problem. For example, if the intensity of the light source is high, the reflectance of a shiny part of the metal product is higher than a part where light reflection is small, and if the intensity of the light source is low, it is difficult to capture the part of the metal product where the light reflection is small. Therefore, according to an exemplary embodiment of the present disclosure, the computing device 100 may first reduce the intensity of light in order to check whether there is no light reflection in the shiny part of the product, and increase the brightness of the one or more images 12 obtained above, the gamma correction (13) is performed to obtain a gamma-corrected image 14 of a clear product without reflection of light. Meanwhile, according to another exemplary embodiment of the present disclosure, the computing device 100 may adjust sizes of the one or more obtained images 12. For example, when a front image of a first product and a front image of a second product have different sizes, the computing device 100 may adjust the two images to the same size. In this case, if a difference between an original image and a resized image is excessively large, a defect inspection task may become much more difficult because small defects of the product may hardly be expressed in the resized image. Therefore, the size of the image may need to be adjusted so that the difference between the original image and the resized image does not become excessively large, and for example, the size to be adjusted may be designated as a size of 380×380 (Height×Width). The size to which the image is adjusted for the one or more obtained images 12 may be experimentally selected, and the size of 380×380 (Height×Width) is only an example, and adjustment of various sizes may be performed for the one or more obtained images 12. Meanwhile, the gamma-corrected image 14 or the resized image may be input into the neural network model and used in a process of generating a plurality of feature maps, and a specific process will be described with reference to FIG. 5 below.

FIG. 5 is a schematic view illustrating a process of inputting the obtained images into a neural network model, extracting features of the images by using a plurality of first convolution layers and a plurality of first pooling layers included in the neural network model, and generating a plurality of feature maps based on the extracted features according to the exemplary embodiment of the present disclosure.

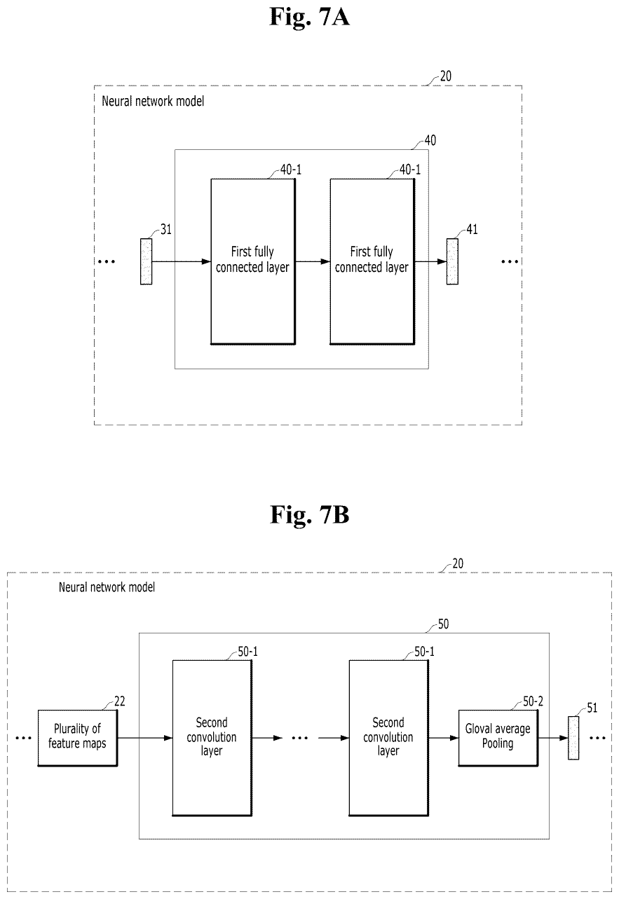

Referring to FIG. 5, the computing device 100 may input the gamma-corrected image 14 into the neural network model 20, extract features of the image 14 by using a plurality of first convolution layers and a plurality of first pooling layers 21 included in the neural network model, and generating a plurality of feature maps 22 based on the extracted features. Specifically, the computing device 100 may input the image 14 for which the gamma correction is performed into a structure 21 in which a plurality of first convolution layers and a plurality of first pooling layers are alternately connected, extract the features of the images 14, and generate the plurality of feature maps 22 based on the extracted features. In this case, the plurality of first convolution layers may be used to extract image features required for classification from the input image. For example, a convolution operation is performed while passing the image 14 through the plurality of first convolution layers, and the passed image is made to pass through the plurality of first pooling layers alternately connected to the plurality of first convolution layers, and Max pooling is performed to extract the features of the input image 14, and the plurality of feature maps 22 may be generated based on the extracted features of the image. At this time, the reason for performing the Max pooling is that \textcircled{1} the largest feature value has the greatest influence on the calculation, so the largest feature value has the greatest influence on the output value and \textcircled{2} represents the feature of the input data the best. However, in an exemplary embodiment of the present disclosure, performing the max pooling by passing the passed image through the plurality of first pooling layers alternately connected to the plurality of first convolution layers is only an example, and in the process of passing the image through the plurality of first pooling layers alternately connected to the plurality of first convolution layers, various poolings such as average pooling may be performed in addition to the max pooling. On the other hand, as the input data passes through the plurality of first pooling layers alternately connected to the plurality of first convolution layers, the dimension of the feature map output from the plurality of first convolution layers is lowered, and the processing time of the model may thus be reduced. For example, the computing device 100 may pass the input image 14 through a structure in which seven first convolution layers and seven first pooling layers are alternately connected. At this time, in order to obtain a useful local pattern in the input image 14, 32 filters having a dimension of 3×3 and a stride (movement amount of the filter) of 1×1 may be used in a first first convolution layer among the seven convolution layers, 64 filters having a dimension of 3×3 and a stride (movement amount of the filter) of 1×1 may be used in second to fifth first convolution layers of the seven convolution layers, and 128 filters with a dimension of 3×3 and a stride (movement amount of the filter) of 1×1 may be used in sixth to last first convolution layers among the seven convolution layers. On the other hand, all activation functions of the plurality of first convolution layers may adopt rectified linear unit (ReLU), the plurality of first pooling layers may be max pooling layers, and the plurality of first pooling layers may include a max pooling layer having a pool size and a stride size of 2×2 applied next to each first convolution layer. For example, when an input tensor shape of the input image 14 is 380×380×3 (height×width×channel), output tensor shapes of a plurality of feature maps 22 generated by passing through a structure in which the seven first convolution layers and the seven first pooling layers are alternately connected may become a form of 2×2×128 (height×width×channel). The generated plurality of feature maps 22 include features required for defect inspection in the input image 14, but when the defect of the product is very small, the similarity between the image with the defect and the image without the defect is very high, so when additional features are used in the input image 14, the accuracy of the neural network model predicting the defect of the product may be increased. Therefore, the computing device 100 may extract a first feature vector, a second feature vector for identifying a feature map related to the presence or absence of the defect among the plurality of feature maps, and a third feature vector for identifying a feature map region related to the presence or absence of the defect based on the plurality of feature maps 22, and a specific process will be described below with reference to FIGS. 6 to 7B.

FIG. 6 is a schematic view illustrating a process of extracting a first feature vector, a second feature vector, and a third feature vector based on a plurality of feature maps according to the exemplary embodiment of the present disclosure.

Referring to FIG. 6, according to an exemplary embodiment of the present disclosure, the computing device 100 may perform global average pooling for the plurality of feature maps 22 (30), and extract a first feature vector 31. In this case, by performing the global average pooling for the plurality of feature maps 22 for each channel, one feature map having a size of H×W which is 2×2 may be converged to one value, so the plurality of feature maps 22 may be extracted as one first feature vector 31. For example, when the plurality of feature maps 22 correspond to feature maps having a size of 2×2 that exist for each of 128 channels, a 1D-shape first feature vector 31 having 128 values may be extracted when performing the global average pooling for a tensor shape of 2×2×128 (Height×Width×Channel). The extracted first feature vector 31 may be used in a process 40 of extracting a second feature vector 41 for identifying a feature map related to the presence or absence of the defect among the plurality of feature maps 22, and may be used in a process of predicting the presence or absence of the defect by using the neural network model 20. A detailed description of the process 40 of extracting the second feature vector 41 will be described below with reference to FIG. 7A.

Meanwhile, referring to FIG. 6, the computing device 100 may extract a third feature vector 51 based on the plurality of feature maps 22 (50). The extracted third feature vector 51 may be used in a process of predicting the presence or absence of the defect by using the neural network model, and a detailed description of the process of extracting the third feature vector 51 will be described later with reference to FIG. 7B.

FIG. 7A is a schematic view illustrating a process of extracting a second feature vector for identifying a feature map related to presence or absence of a defect among the plurality of feature maps based on the extracted first feature vector according to the exemplary embodiment of the present disclosure.

Referring to FIG. 7A, the computing device 100 may input the extracted first feature vector 31 into one or more first fully-connected layers, and extract the second feature vector 41 for identifying the feature map related to the presence or absence of the defect among the plurality of feature maps 22. For example, the global average pooling is performed on the plurality of feature maps 22 to remove spatial information, and the first feature vector 31 with only channel information remaining is input into two first fully-connected layers 40-1, so an importance level is learned for each channel, and the second feature vector 41 for identifying the feature map related to the presence or absence of the defect among the plurality of feature maps 22 may be extracted (40). For example, the second feature vector 41 may be calculated and extracted based on the following equation.

Second feature vector=FC₂(FC₁(first feature vector)) [Equation 1]

In Equation 1 above, FC1 may mean a first layer of the two first fully-connected layers 40-1, FC2 may mean a second layer of the two first fully-connected layers 40-1, and a hidden layer of the FC1 may be set to 128 and the hidden layer of the FC2 may be set to 64, and through this, a size of the second feature vector 41 may be extracted as 64. Meanwhile, the process of extracting the second feature vector 41 of FIG. 7A may include a channel attention process of focusing on requirement input feature points by utilizing the interdependency between channels, compressing channel information using Global Average Pooling (GAP), restoring the input feature points through the convolution layer, and reinforcing and restoring the input feature points for the part to be focused within the network.

Through the channel attention process, it is possible to extract a feature map most related to the presence or absence of the defect among the plurality of feature maps 22, and an output value of channel attention may be applied in a defect prediction process through a process of concatenating the second feature vector 41 including information on the feature map most related to the presence or absence of the defect with another feature vector (first or third feature vector). A detailed description thereof will be described below with reference to FIG. 8.

FIG. 7B is a schematic view illustrating a process of extracting a third feature vector for identifying a feature map region related to presence or absence of a defect based on the plurality of feature maps according to the exemplary embodiment of the present disclosure.

Referring to FIG. 7B, the computing device 100 may input the generated plurality of feature maps 22 into one or more second convolution layers 50-1, and extract a third feature vector 51 for identifying a feature map region related to the presence or absence of the defect. For example, the computing device 100 may input the plurality of feature maps into three second convolution layers 50-1, apply the convolution operation to delete information on a channel and generate a feature map having a spatial importance, and perform global average pooling 50-2 for the feature map having the generated spatial importance to extract the third feature vector 51 for identifying the feature map region related to the presence or absence of the defect. Through this, the extracted third feature vector 51 may include “information on an important region in defect inspection for the feature maps having the spatial importance”.

For example, the third feature vector 51 may be calculated and extracted based on the following equation.

Third feature vector=GAP(Z₃^{1×1}(Z₂^{3×3}(Z₁^{1×1}(feature map)))) [Equation 2]

In Equation 2, Z1, Z2, and Z3 may mean first, second, and third layers of three second convolution layers 50-1, respectively, and GAP may mean the global average pooling 50-2. In addition, the Z1 layer and the Z3 layer may include 64 filters having a size of 1×1, and the Z2 layer may include 64 filters having a size of 3×3. Since the computing device 100 may input the plurality of feature maps 22 to three second convolution layers 50-1 of Z1, Z2, and Z3, and apply the convolution operation to delete channel information and generate the feature map having the spatial importance, and perform the global average pooling 50-2 for the generated feature map having the spatial importance to converge to one value the feature map having one spatial importance having a size of Height×Width which is 2×2, the computing device 100 may extract feature maps having the spatial importance as one third feature vector 51. For example, when the feature maps having the spatial importance correspond to feature maps having a size of 2×2 that exist for each of 64 channels, a 1D-shape third feature vector 51 having 64 values may be extracted when performing the global average pooling for a tensor shape of 2×2×64 (Height×Width×Channel). On the other hand, the process of extracting the third feature vector 51 of FIG. 7B may include a spatial attention process which may play a role of intensively distinguishing locations (center, corner, left, right, etc.) of respective pixels in the image.

The extracted third feature vector 51 may extract “information on an important region in defect inspection for the feature maps having the spatial importance” through the spatial attention process, and the output value of the spatial attention may be applied in the defect prediction process through a process of concatenating the third feature vector 51 including information on the feature map region related to the presence or absence of the defect with another feature vector (first or second feature vector). A detailed description thereof will be described below with reference to FIG. 8.

FIG. 8 is a schematic view illustrating a process of predicting presence or absence of a defect based on a first feature vector, a second feature vector, and a third feature vector by using a neural network model according to the exemplary embodiment of the present disclosure.

Referring to FIG. 8, the computing device 100 may generate a first synthesized vector 52 by concatenating the second feature vector 41 and the third feature vector 51. For example, when the second feature vector 41 is a one-dimensional vector having 64 values and the third feature vector 51 is a one-dimensional vector having 64 values, the first synthesized vector 52 may be generated by concatenating both vectors. In this case, since the second feature vector 41 includes the information on the feature most related to the presence or absence of the defect in the plurality of feature maps 22, and the third feature vector 51 includes the information on the feature map region related to the presence or absence of the defect among the plurality of feature maps 22, the two vectors 41 and 51 are complementary to each other, and the first synthesized vector 52 generated by concatenating the two vectors 41 and 51 may include both the information on the feature most related to the presence or absence of the defect in the plurality of feature maps 22 and the information on the feature map region related to the presence or absence of the defect.

The computing device 100 may generate a final synthesized vector 53 by concatenating the first synthesized vector 52 and the first feature vector 31, and predict the presence or absence of the defect based on the final synthesized vector 53. For example, the first synthesized vector 52 including both the information on the feature most related to the presence or absence of the defect in the plurality of feature maps 22 and the information on the feature map region related to the presence or absence of the defect is concatenated with the first feature vector 31 including the information on the features required for defect inspection of the plurality of feature maps 22, so the final synthesized vector 53 may include information in which the information on the feature most related to the presence or absence of the defect in the plurality of feature maps 22 and the information on the feature map region related to the presence or absence of the defect are reflected to the information on the features required for defect inspection of the plurality of feature maps 22. Therefore, the final synthesized vector 53 may be input into one or more second fully-connected layers 54, and the neural network model 20 may predict the presence or absence of the defect of the product by using a SoftMax function (55). According to an exemplary embodiment of the present disclosure, by predicting the presence or absence of the defect of the product based on the 2D image, there is a technical effect of lower cost and faster prediction speed than the method using the 3D camera. Further, “the process of extracting the second feature vector 41 for identifying the feature map related to the presence or absence of the defect among the plurality of feature maps 22” and “the process of extracting the third feature vector 51 for identifying the feature map region related to the presence or absence of the defect” corresponding to the channel attention process and the spatial attention process, respectively are performed in parallel, and two vectors 41 and 51 which are complementary are jointly used in the defect prediction process, so there is technical effect in that the accuracy of the defect prediction may be increased. The neural network model 20 used to predict the defect of the product may be learned through a data set of 80%, which is training data, among a data set consisting of 80% for training and 20% for testing, and the image input into the neural network model included in the data set may be set to a dimension of 380×380×3 (Height×Width×Channel), and as a loss function used to learn the neural network model 20, cross entropy (CE) loss may be used.

Experimental data related to the technical effect of the neural network model 20 is described with reference to the following table.

<Accuracy Comparison Table of Prediction Performing Results for Neural Network Model 20 According to Whether First, Second, and Third Feature Vectors are Used>

In the comparison table, MODEL-1 is a neural network model that performs defect prediction using only the first feature vector 31, MODEL-2 is a neural network model that performs defect prediction using the first feature vector and second feature vectors, MODEL-3 is a neural network model that performs defect prediction using the first feature vector and the third feature vector, and MODEL-4 is a neural network model (corresponding to the neural network model 20 according to an exemplary embodiment of the present disclosure) that performs defect prediction by using the first, second, and third feature vectors. Accuracy may mean the accuracy of the defect prediction.

Referring to the table, it can be seen that “the neural network model 20 performing defect prediction according to an exemplary embodiment of the present disclosure” perform the defect prediction more accurately than “the neural network model that performs defect prediction using only the first feature vector 31”, “the neural network model that performs defect prediction using the first feature vector 31 and the second feature vector 41”, and “the neural network model that performs defect prediction by using the first feature vector 31 and the third feature vector 51”.

Disclosed is a computer readable medium storing the data structure according to an exemplary embodiment of the present disclosure.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

In the present disclosure, a network function, an artificial neural network, and a neural network may be used to be exchangeable. From here on, it will be described uniformly using neural networks.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include training data input in a neural network training process and/or input data input to a neural network in which training is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto. The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network training process and/or a weight in which neural network training is completed. The weight which varies in the neural network training process may include a weight at a time when a training cycle starts and/or a weight that varies during the training cycle. The weight in which the neural network training is completed may include a weight in which the training cycle is completed. Accordingly, the data structure including the weight of the neural network may include a data structure including the weight which varies in the neural network training process and/or the weight in which neural network training is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of training cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

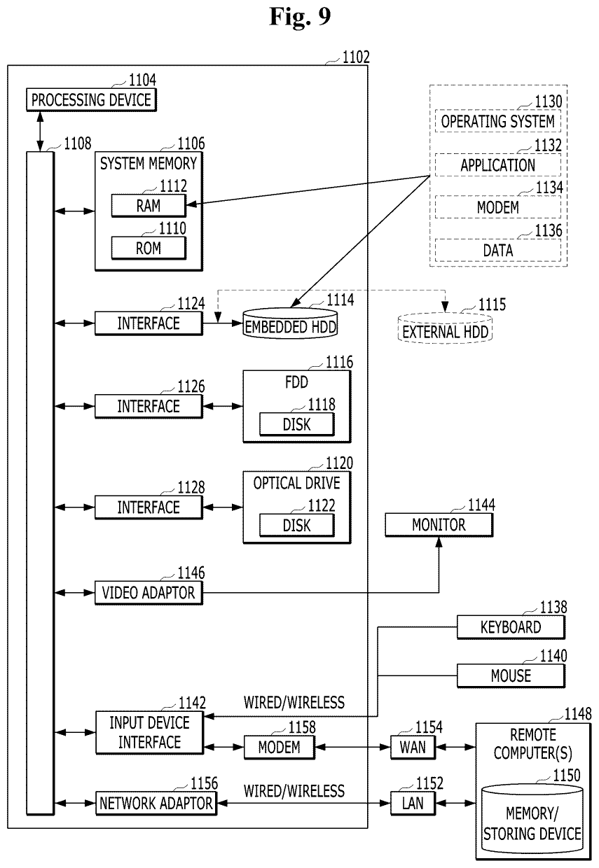

FIG. 9 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto. The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure. Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for predicting presence or absence of a defect of a product, the method performed by a computing device, the method comprising:
obtaining one or more images;
inputting the obtained image into a neural network model, and generating a plurality of feature maps;
extracting a first feature vector based on the plurality of feature maps;
extracting a second feature vector for identifying a feature map related to the presence or absence of the defect among the plurality of feature maps based on the extracted first feature vector;
extracting a third feature vector for identifying a feature map region related to the presence or absence of the defect based on the plurality of feature maps; and
predicting the presence or absence of the defect based on the first feature vector, the second feature vector, and the third feature vector by using the neural network model.

2. The method of claim 1, wherein the one or more images include one or more 2D images, and
the obtaining of the one or more images includes obtaining one or more images of a front image, a back image, a right image, a left image, a top image, or a bottom image of the product.

3. The method of claim 1, wherein the inputting of the obtained image into the neural network model, and the generating of the plurality of feature maps includes:
performing gamma correction for the obtained image, and
inputting the gamma-corrected image into the neural network model.

4. The method of claim 1, wherein the inputting of the obtained image into the neural network model, and the generating of the plurality of feature maps includes:
extracting features of the image by using a plurality of first convolution layers and a plurality of first pooling layers included in the neural network model, and
generating the plurality of feature maps based on the extracted features.

5. The method of claim 1, wherein the extracting of the first feature vector based on the plurality of feature maps includes:
extracting the first feature vector by performing additional pooling on the plurality of feature maps.

6. The method of claim 1, wherein the extracting of the second feature vector for identifying the feature map related to the presence or absence of the defect among the plurality of feature maps based on the extracted first feature vector includes:
inputting the first feature vector into one or more first fully-connected layers, and extracting the second feature vector for identifying a feature map related to the presence or absence of the defect among the plurality of feature maps.

7. The method of claim 1, wherein the extracting of the third feature vector for identifying the feature map region related to the presence or absence of the defect based on the plurality of feature maps includes:
inputting the plurality of feature maps into one or more second convolution layers, and applying a convolution operation, and
performing additional pooling for the feature maps to which the convolution operation is applied, and extracting the third feature vector for identifying the feature map region related to the presence or absence of the defect.

8. The method of any one of claims 5 to 7, wherein the additional pooling includes global average pooling.

9. The method of claim 1, wherein the predicting the presence or absence of the defect based on the first feature vector, the second feature vector, and the third feature vector by using the neural network model includes:
generating a first synthesized vector by concatenating the second feature vector and the third feature vector,
generating a final synthesized vector by concatenating the first synthesized vector and the first feature vector, and
predicting the presence or absence of the defect based on the final synthesized vector.

10. The method of claim 9, wherein the predicting the presence or absence of the defect based on the final synthesized vector includes:
inputting the final synthesized vector into one or more second fully-connected layers and predicting the presence or absence of the defect.

11. A computer program stored in a non-transitory computer-readable storage medium, wherein the computer program allows one or more processors to perform operations for predicting presence or absence of a defect of a product when the computer program is executed by one or more processors, the operations comprising:
an operation of obtaining one or more images;
an operation of inputting the obtained image into a neural network model, and generating a plurality of feature maps;
an operation of extracting a first feature vector based on the plurality of feature maps;
an operation of extracting a second feature vector for identifying a feature map related to the presence or absence of the defect among the plurality of feature maps based on the extracted first feature vector;
an operation of extracting a third feature vector for identifying a feature map region related to the presence or absence of the defect based on the plurality of feature maps; and
an operation of predicting the presence or absence of the defect based on the first feature vector, the second feature vector, and the third feature vector by using the neural network model.

12. A computing device comprising:
at least one processor; and
a memory,
wherein the at least one processor is configured to
obtain one or more images,
input the obtained image into a neural network model, and generate a plurality of feature maps,
extract first feature vector based on the plurality of feature maps,
extract a second feature vector for identifying a feature map related to presence or absence of a defect among the plurality of feature maps based on the extracted first feature vector,
extract a third feature vector for identifying a feature map region related to the presence or absence of the defect based on the plurality of feature maps, and
predict the presence or absence of the defect based on the first feature vector, the second feature vector, and the third feature vector by using the neural network model.
